(19) United States
(12) Patent Application Publication
(10) Pub. No.: US 2003/0170545 A1
(43) Pub. Date: Sep. 11, 2003

(54) Cell incorporating a porous membrane

(76) Inventors: Fazlil Coowar, Sugarland (GB); Vijay Dass, Oxfordshire (GB)

Correspondence Address: Law Offices Of William H Holt, 1423 Powhatan Street, Unit 2, First Floor, Alexandria, VA, 22314, US

(21) Appl. No.: 10/311,062

(22) PCT Filed: Jun. 12, 2001
(86) PCT No.: PCT/GB01/02550

(30) Foreign Application Priority Data
Jun. 15, 2000 (GB) 0014464.2

(51) Int. Cl. H01M 10/40; H01M 10/04

(52) U.S. Cl. 429/309; 29/623.5; 429/316

(57) ABSTRACT

A lithium ion cell incorporates a porous polymer membrane, for example a microporous membrane. The porous polymer membrane is sandwiched between electrode layers comprising particulate insertion materials and a polymer binder. The assembled cell is then contacted with a solution comprising lithium salt, one or more organic plasticisers, and a different polymer soluble in the plasticisers, so the solution is absorbed into the porous membrane and into the electrode layers, and the solution then gels so that the components are bonded together. This procedure enables cells to be made with thin electrolyte layers, for example less than 30 μm thick.

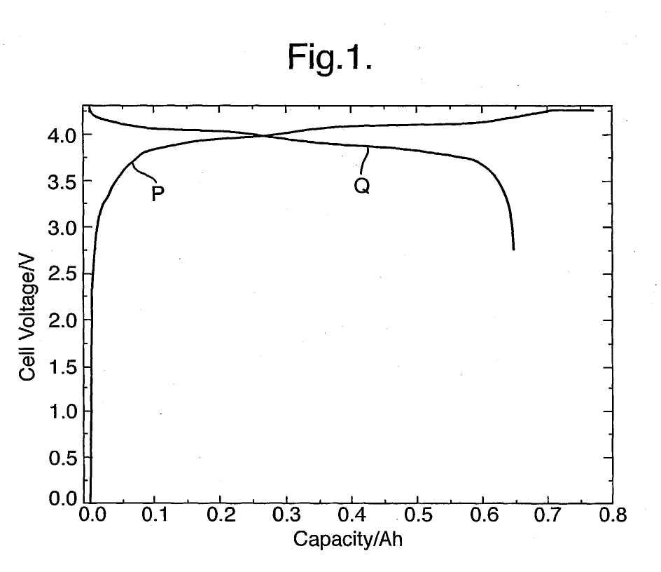

This invention relates to a way of making a lithium ion polymer cell, in which the cell electrolyte comprises a porous polymer membrane for example of a polymer such as polyvinylidene fluoride, and to a cell made by that method.

For many years it has been known to make cells with lithium metal anodes, and cathodes of a material into which lithium ions can be intercalated or inserted. Such cells may use, as electrolyte, a solution of a lithium salt in an organic liquid such as propylene carbonate, and a separator such as filter paper or polypropylene. The use of a solid-state ion-conducting polymer such as a complex of a lithium salt with poly-(ethylene oxide) has also been suggested as an electrolyte. In the case of secondary or rechargeable lithium cells, the use of lithium metal anodes is unsatisfactory as problems arise from dendrite growth, but the use of an intercalation material such as graphite has enabled satisfactory cells to be made. Such cells may be referred to as “lithium ion” cells, or “swing” cells, as lithium ions are exchanged between the two intercalation materials during charge and discharge.

An alternative type of polymer electrolyte was proposed by Gozdz et al (U.S. Pat. No. 5,296,318), which comprises a copolymer of 75 to 92% vinylidene fluoride and 8 to 25% hexafluoropropylene, blended with a lithium salt and a compatible solvent such as ethylene carbonate/propylene carbonate mixture and cast from solution in a low boiling-point solvent such as tetrahydrofuran. GB 2 309 703 B (AEA Technology) describes a similar electrolyte composition in which the polymer is polyvinylidene fluoride (PVdF) homopolymer, the PVdF being characterised by a very low melt flow index. It is also possible to make such a solid polymer electrolyte by first making a porous film of the polymer material, and then immersing the film in a solution of lithium salt in an organic solvent so the electrolyte solution combines with the polymer film, as described in EP 0 730 316 A (Elf Atochem). Pending application PCT/GB00/04889 describes a method of making a microporous membrane from a polymer consisting at least primarily of vinylidene fluoride, and such films can be less than 50 μm thick. However, with films less than say 30 μm thick it becomes difficult to laminate the electrolyte layer to the electrode layers without risk of shorting when using conventional lamination techniques that require application of pressure and raised temperatures.

According to the present invention there is provided a method of making a lithium ion polymer cell comprising an anode layer, and a cathode layer each comprising respective lithium ion insertion materials, separated by a porous membrane, wherein the anode layer and the cathode layer each incorporates a polymeric binder, the method comprising assembling the anode layer, the porous membrane, and the cathode layer, and impregnating the assembly with a solution comprising a lithium salt in a plasticising solvent, the solution also comprising a polymeric material that is different from the polymer of the polymeric binder and that of the porous membrane, and is soluble in the plasticising solvent.

The polymeric material in the solution subsequently causes the solution to gel, thereby bonding the layers together. The polymeric material in the solution must be different from that of the porous membrane, but for example may comprise polyacrylonitrile, polyvinylidene fluoride (PVdF) homopolymer, or a copolymer or terpolymer consisting primarily of vinylidene fluoride, and may comprise a polymer in which the polymeric chain consists primarily of vinylidene fluoride, onto which is grafted a mono-unsaturated carboxylic, sulphonic or phosphonic acid, ester, amide or substituted amide. Such grafting alters the solubility of the polymer, and also improves the adhesion properties of the electrolyte. The polymer of the porous membrane must be insoluble in the plasticising solvent, as also must the polymeric binder in the electrode layers, and may for example also be a polymer consisting primarily of vinylidene fluoride, although different from that in the solution, for example a high molecular weight homopolymer PVdF. The gelling of the solution may occur as a result of a temperature decrease (from above ambient to ambient), or may be due to interaction of the plasticising solvent with the polymer of the porous membrane.

Where a grafted polymer is to be used, the monomer to be grafted onto the polymer chain should have only one double-bond in the carbon chain R—, and one or more carboxyl groups —COOH, sulphonic acid groups —SO₂OH, phosphonic acid groups —PO(OH)₂, ester groups —COOR′, or amide groups —CONH₂ or —CONR′₂. Generally smaller monomers, with less than five carbon atoms in the carbon chain R—, are preferable. For example acrylic acid; crotonic acid, vinylacetic acid, methylacrylic acid (which are isomers of butenoic acid); isomers of pentenoic acid such as allylacetic acid; etc. The corresponding amides (and substituted amides) may also be used. In an ester, the group R′ might be methyl, ethyl or butyl; for example esters such as methyl acrylate or butyl acrylate may be used. Some preferred monomers for grafting are acrylic acid or dimethyl acrylamide, but a range of other monomers that incorporate the vinyl group are also suitable.

Such grafting can be achieved by an irradiation process. For example the polymer chain substrate and the graft monomer material together may be subjected to continuous or intermittent irradiation; or more preferably the substrate is pre-irradiated before being brought into contact with the monomer material. The irradiation may be with an electron beam, or X-rays. The irradiation activates the substrate (the polymer chain) apparently by generating free radicals. The degree of grafting is determined by several factors, the most important being the extent of pre-activation of the polymer substrate by the irradiation, the length of time that the activated polymer is in contact with the graft monomer material, the extent to which the monomer can penetrate the polymer, and the temperature of the polymer and the monomer when in contact. The degree of grafting in the resulting material is desirably between 2 and 20% of the final weight, more preferably between 3 and 12%, for example 5% or 10%.

The plasticising solvent in the solution that contains the lithium salt must not be detrimental to the electrical properties of the cell. The preferred plasticising solvent includes ethylene carbonate (EC) and either dimethyl carbonate (DMC) or methyl propyl carbonate (MPC). Such a solvent not only provides good electrical properties in the resulting cell, but also acts as a solvent for a range of polymers at an elevated temperature such as above 50° C.

The porous membrane is preferably microporous, with pores which are preferably between 0.1 and 10 μm across, more preferably between 0.5 and 2 μm. Such a microporous membrane may be cast from a solvent/non-solvent mixture, or from a latent solvent, so that the entire process can be carried out in the absence of water or humidity, reducing the risk of water being present in the final film or membrane (which would be detrimental to the properties of a lithium cell). The non-solvent should not only dissolve in the solvent, but it should be miscible with the solvent in substantially all proportions. The boiling point of the non-solvent is preferably higher than that of the solvent, preferably about 20° C. higher. For example the solvent might be dimethyl formamide or dimethyl acetamide, in which case a suitable non-solvent is 1-octanol which is soluble in those solvents and whose boiling point is about 194° C. Alternative non-solvents would be 1-heptanol, for which the boiling point is about 175° C.; 2-octanol, for which the boiling point is about 179° C.; 4-octanol, for which the boiling point is about 175° C.; or 3-nonanol, for which the boiling point is about 193° C.

In making a microporous membrane the evaporation rate during drying must not be rapid, as rapid drying tends to produce macropores, and also may lead to formation of an impervious skin which prevents evaporation of underlying liquid. When using a latent solvent, the drying process should be carried out at a temperature below the dissolution temperature for the latent solvent. Consequently the polymer precipitates, and it is believed that two phases occur: a polymer-rich phase, and a polymer-poor phase. As the latent solvent evaporates the proportion of the polymer-rich phase gradually increases, but the remaining droplets of polymer-poor phase cause the formation of pores.

The invention will now be further and more particularly described, by way of example only, and with reference to the accompanying drawing which shows charge and discharge graphs for a cell of the invention.

Making the Porous Membrane

Homopolymer PVdF (Solvay grade 1015), which is characterised by having a low value of melt flow index (about 0.7 g/10 min at 10 kg and 230° C.), is dissolved in dimethyl formamide (DMF) at a temperature of 45° C. while stirring; 15 g of PVdF were dissolved in 85 g of DMF. A small quantity, 9 g, of 1-octanol is then added dropwise to the polymer solution, and carefully mixed during this addition to ensure the mixture is homogeneous. The quantity of 1-octanol must not be too large, or the solution will gel. The resulting ternary mixture is then cast, using a doctor blade over a roller, onto an aluminium foil substrate to form a layer initially 0.25 mm thick, and then passed through a 7 m long drying tunnel with two successive drying zones at temperatures of 65° C. and 100° C. respectively. It moves through the drying tunnel at 0.5 m/min. Within the drying zones the film is exposed to a dry air flow with a velocity of 14 m/s, to remove any solvent and non-solvent that evaporates. The dry air is obtained by passing air through a dehumidifier.

During passage of the film through the drying tunnel, which takes 14 minutes, both the solvent and non-solvent gradually evaporate (although they are both well below their boiling points), the solvent tending to evaporate more rapidly. A white polymer membrane is thereby obtained, of thickness about 20-25 μm, which is then peeled off the substrate, and analysis with a scanning electron microscope shows it to be microporous.

The pores are of size in the range 0.5-2.0 μm, typically about 1 μm in diameter.

The microporous membrane is subsequently dried in a vacuum to ensure removal of all traces of both solvent and non-solvent.

Making the Electrodes

A cathode is made by making a mixture of spinel LiMn₂O₄, a small proportion of conductive carbon, and homopolymer PVdF 1015 as binder (as mentioned above), this being cast from solution in N-methyl-pyrrolidone (NMP) which is a solvent for the PVdF. The mixture is cast, using a doctor blade, onto an aluminium foil, being passed through a dryer with temperature zones at for example 80° C. and 120° C.,-to ensure evaporation of all the NMP (of which the boiling point is about 203° C.). This process may be repeated to produce a double-sided cathode. Removal of the NMP may be further ensured by subsequent vacuum drying.

An anode is made by making a mixture of mesocarbon microbeads of particle size 10 μm, heat treated at 2800° C. (MCMB 1028), with a small amount of graphite, and homopolymer PVdF 1015 as binder. This mixture is cast from solution in NMP, onto a copper foil, in a similar fashion to that described in relation to the cathode.

Cell Assembly

A prismatic wound flat cell is then assembled with the porous membrane separating the anode from the cathode. These cells were vacuum dried at 60° C. for several hours to ensure removal of all the casting solvents and any traces of water.

Electrolyte Solution Preparation

A 10% (by weight) solution of a copolymer of vinylidene fluoride and hexafluoropropylene containing 6% by weight of hexafluoropropylene (PVdF/GHFP) is made by dissolving the polymer in a mixture of ethylene carbonate and dimethyl carbonate. For example 3.75 g PVdF/6HFP may be dissolved in 19 g DMC mixed with 15 g of ethylene carbonate, while stirring, at a temperature of 55° C. While maintaining the temperature at this value, an electrolyte mixture of ethylene carbonate, ethyl methyl carbonate, and one or more lithium salts are mixed with this, to form a clear homogeneous solution. For example these salts might be LiPF₆ and/or LiBF₄. The proportion of electrolyte mixture in this final solution in this example is 50%, but might be between 25 and 75%, and the concentration of the lithium salt in the final solution is 0.5 M, but might instead be in the range 0.3 M to 1.5 M, for example.

Cell Completion

The solution containing both lithium salt and PVdF/6HFP at a temperature of 55° C. is then injected into the dried cells, and the cells left to soak at ambient temperature for several hours so all the components are thoroughly impregnated by the solution.

It has been found that all the layers, that is to say the cathode layer, the anode layer, and the porous membrane separator, are bonded together as a result of the gelling of the solution. No separate lamination step is required, and the application of heat and pressure is avoided. Nevertheless good quality cells can be made with electrolyte layers of thickness only 20-25 μm. Each cell is then vacuum-packed and sealed, for example in a flexible laminated aluminium foil pack.

The resulting cells have good electrical properties. For example, referring to the figure this shows the variation of voltage with capacity for the first charge and discharge cycle for such a cell, charging and then discharging at the C/5 rate between voltages of 2.75 V and 4.25 V. (The cell was first charged at an estimate of the C/5 rate, and the observed capacity during that charge enabled a more accurate measure of cell capacity C to be obtained.) The charging graph is marked P and the discharging graph is marked Q. A discharge capacity of 0.647 Ah was obtained, and a coulombic efficiency of 83%. The cell was then cycled several times at the C/5 rate with only slight decrease in capacity, the capacity remaining above 0.62 Ah after 10 cycles.

The gelling of the solution may be due merely to the decrease in temperature as the solution, initially at above 50° C., cools to ambient temperature. Alternatively the solution may gel as a consequence of absorption of plasticising solvent by the porous membrane. Indeed both these phenomena may occur.

It will be appreciated that cells may differ from those described above, while remaining within the scope of the invention. In particular the electrode materials may differ from those described above, for example the cathode material might instead be a material such as LiCoO₂, or LiNiO₂, or LiNi_{1-x-y}COₓM_{y}O₂ where M is another metal, or vanadium oxide based material. The anode material might be a lithium alloy, tin oxide, lithium titanates, natural graphite, synthetic graphite, or hard carbon, for example. The dissolution of PVdF/6HFP might take place in a mixture of methyl propyl carbonate and ethylene carbonate, or γ-butyrolactone+EC (instead of DMC and EC). And the polymer dissolved in the solution might be a different polymer, for example PVdF/2HFP (vinylidene fluoride with 2% hexafluoropropylene). The cell might be assembled by folding or stacking the electrode layers and the porous membrane, instead of winding.

1. A method of making a lithium ion cell comprising an anode layer, and a cathode layer each comprising respective lithium ion insertion materials, separated by a porous membrane, wherein the anode layer and the cathode layer each incorporates a polymeric binder, the method comprising assembling the anode layer, the porous membrane, and the cathode layer, and impregnating the assembly with a solution comprising a lithium salt in a plasticising solvent, characterised by the solution also comprising a polymeric material that is different from the polymer of the polymeric binder and that of the porous membrane, and is soluble in the plasticising solvent.

2. A method as claimed in claim 1 in which the polymeric material in the solution comprises polyacrylonitrile, polyvinylidene fluoride (PVdF) homopolymer, or a copolymer or terpolymer consisting primarily of vinylidene fluoride, or a polymer in which the polymeric chain consists primarily of vinylidene fluoride, onto which is grafted a mono-unsaturated carboxylic, sulphonic or phosphonic acid, ester, amide or substituted amide.

3. A method as claimed in claim 1 or claim 2 in which the polymer of the porous membrane and the polymeric binder in the electrode layers consist primarily of vinylidene fluoride, although being different from that in the solution.

4. A method as claimed in any one of the preceding claims in which the plasticising solvent includes ethylene carbonate (EC) and either dimethyl carbonate (DMC) or methyl propyl carbonate (MPC).

5. A method making a lithium ion cell substantially as hereinbefore described with reference to the accompanying drawing.

6. A lithium ion cell made by a method as claimed in any one of the preceding claims.

7. A lithium ion cell as claimed in claim 6 wherein the porous membrane is microporous, with pores which are between 0.1 and 10 μm across, more preferably between 0.5 and 2 μm.
